(19) United States
(12) Patent Application Publication
(10) Pub. No.: US 2020/0402281 A1
(43) Pub. Date: Dec. 24, 2020

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Kazuna Maruyama, Fuchu-shi (JP)

(21) Appl. No.: 16/901,351

(22) Filed: Jun. 15, 2020

(30) Foreign Application Priority Data
Jun. 18, 2019 (JP) 2019-112702

(51) Int. Cl. G06T 11/60; H04N 5/268; G06T 7/70

(52) U.S. Cl. CPC G06T 11/60; G06T 2207/30228; G06T 7/70; H04N 5/268

(57) ABSTRACT

An image processing apparatus includes: a first identifying unit configured to identify image-capturing conditions concerning a position and an orientation of an image-capturing apparatus which obtains a captured image of an image-capturing target region; a second identifying unit configured to identify viewpoint conditions concerning a position and an orientation of a virtual viewpoint for a virtual viewpoint image generated based on a plurality of images of the image-capturing target region obtained by a plurality of the image-capturing apparatuses at different positions; and a display control unit configured to allow a display apparatus to display information indicating a degree of match between the identified image-capturing conditions and the identified viewpoint conditions before an image presented to a viewer is switched between the captured image and the virtual viewpoint image.

### BACKGROUND OF THE INVENTION

### Field of the Invention

The present invention relates to a virtual viewpoint image generated from multi-viewpoint images captured using a plurality of cameras.

### Description of the Related Art

In recent years, attention has been paid to a technique of installing a plurality of cameras at different positions, synchronously capturing images from multiple viewpoints, and generating a virtual viewpoint image using the multi-viewpoint images thus captured (see Japanese Patent Laid-Open No. 2008-015756). With the technique of generating such a virtual viewpoint image, highlight scenes of soccer or basketball can be viewed from various angles, for example. Therefore, it is possible to give the viewer a higher presence than in the case of the conventional image.

In addition, in the case where an event such as a soccer game is also captured by a broadcast camera or the like, the virtual viewpoint image and the actual camera image captured by the broadcast camera or the like with a switching manner can be broadcast on television or webcast on the Internet. For example, in a goal scene, images can be generated by switching from a virtual viewpoint image seen from the goalkeeper's eyes where the ball jumping in front of the goalkeeper passes through the goalkeeper's side to an actual camera image with the expression of the goalkeeper or kicker zoomed in. As described above, by using the virtual viewpoint image together with the conventional actual camera image, it is possible to provide the viewer with a more realistic image experience.

In the case of using the virtual viewpoint image and the actual camera image while switching them as described above, the viewer may be given a discontinuous impression of the images due to a large difference between movements of the cameras before and after the image switching.

### SUMMARY OF THE INVENTION

In an embodiment of the present invention, an image processing apparatus includes: a first identifying unit configured to identify image-capturing conditions concerning a position and an orientation of an image-capturing apparatus which obtains a captured image of an image-capturing target region; a second identifying unit configured to identify viewpoint conditions concerning a position and an orientation of a virtual viewpoint for a virtual viewpoint image generated based on a plurality of images of the image-capturing target region obtained by a plurality of image-capturing apparatuses at different positions; and a display control unit configured to allow a display apparatus to display information indicating a degree of match between the identified image-capturing conditions and the identified viewpoint conditions before an image presented to a viewer is switched between the captured image and the virtual viewpoint image.

Further features of the present invention will become apparent from the following description of exemplary embodiments with reference to the attached drawings.

### BRIEF DESCRIPTION OF THE DRAWINGS

FIG. 1 is an overall configuration diagram of an image processing system according to the first embodiment;

FIG. 2 is a hardware configuration diagram of the image processing apparatus according to the first embodiment;

FIGS. 3A, 3B, and 3C each provide a processing flowchart of switching section control according to the first embodiment;

FIG. 4 is a processing flowchart of a switching support information presentation in the first embodiment;

FIGS. 5A, 5B, 5C, 5D, 5E, 5F, and 5G each provide a diagram illustrating a presentation example of the switching support information according to the first embodiment;

FIGS. 6A, 6B, and 6C each provide a diagram illustrating a presentation example of a composition adjustment state according to the first embodiment;

FIG. 7 is an overall configuration diagram of an image processing system according to the second embodiment;

FIGS. 8A, 8B, and 8C each provide a processing flowchart of switching section control according to the second embodiment;

FIGS. 9A, 9B, and 9C provide diagrams illustrating the details of automatic operation of the virtual camera and the details of post-switching operation restriction in the second embodiment;

FIG. 10 is a processing flowchart of determining the details of post-switching operation restriction in the second embodiment; and

FIG. 11 is an overall configuration diagram of an image processing system according to the third embodiment.

### DESCRIPTION OF THE EMBODIMENTS

Hereinafter, with reference to the attached drawings, the present invention is explained in detail in accordance with preferred embodiments. Configurations shown in the following embodiments are merely exemplary and the present invention is not limited to the configurations shown schematically.

### First Embodiment

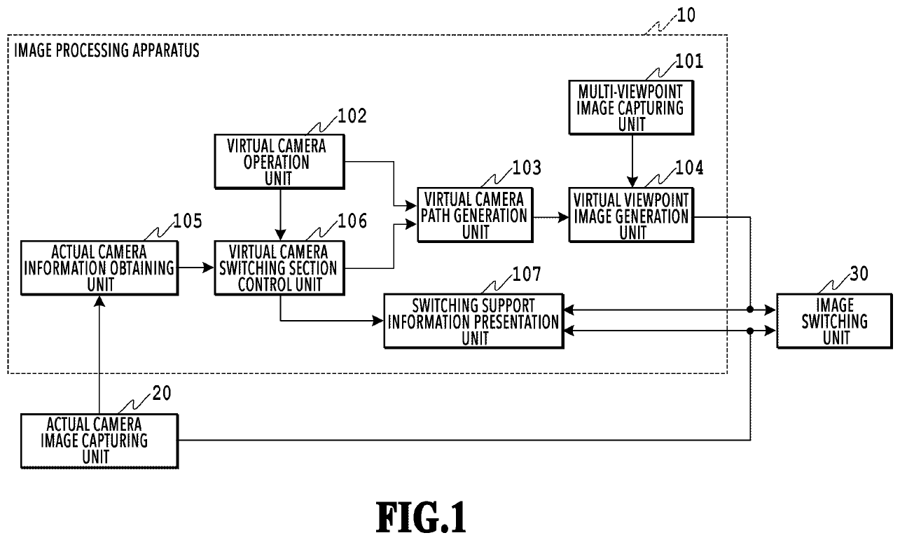

FIG. 1 is an overall configuration diagram of an image processing system to which the first embodiment of the present invention is applied. The image processing apparatus 10 is a system that generates a virtual viewpoint image representing an appearance from a designated virtual viewpoint based on a plurality of images captured by a plurality of image-capturing apparatuses at different positions and on the designated virtual viewpoint. The virtual viewpoint image in the present embodiment is also called a free viewpoint image, but is not limited to an image corresponding to a viewpoint freely (arbitrarily) designated by the user. For example, an image corresponding to a viewpoint selected by the user from a plurality of candidates is also included in the virtual viewpoint image. In addition, in the present embodiment, description is provided mainly for the case where the virtual viewpoint image is a video, but the virtual viewpoint image may be a static image. That is, the image processing apparatus 10 may process a video or may process a static image.

Also, the virtual camera in the present embodiment is a virtual camera different from a plurality of image-capturing apparatuses actually installed, and is a concept for conveniently describing a virtual viewpoint related to the generation of a virtual viewpoint image. That is, the virtual viewpoint image can be regarded as an image captured from a virtual viewpoint set in a virtual space associated with the image-capturing region. Then, the position and orientation of the viewpoint in the virtual image-capturing can be represented as the position and orientation of the virtual camera. In other words, the virtual viewpoint image can be said to be an image simulating a captured image obtained by a camera assumed to be present at the position of the virtual viewpoint set in the space. For this reason, hereinafter, the virtual viewpoint image is also referred to as a virtual camera image. Moreover, in the present embodiment, the content of the change of virtual viewpoint over time is described as a virtual camera path. Note that it is not essential to use the concept of a virtual camera to embody the configuration of the present embodiment. That is, it suffices that at least information indicating a specific position direction in the space is set, and that a virtual viewpoint image is generated according to the set information.

The image processing apparatus 10 includes a multi-viewpoint image capturing unit 101, a virtual camera operation unit 102, a virtual camera path generation unit 103, a virtual viewpoint image generation unit 104, an actual camera information obtaining unit 105, a virtual camera switching section control unit 106, and a switching support information presentation unit 107.

The multi-viewpoint image capturing unit 101 performs synchronous capturing with a plurality of cameras installed so as to surround a competition field or the like to be captured, and passes the captured multi-viewpoint images to the virtual viewpoint image generation unit 104.

The virtual camera operation unit 102 performs virtual camera control by the virtual camera operator, and passes the control results as virtual camera parameters to the virtual camera path generation unit 103. Here, the virtual camera parameters include at least parameters indicating the position and attitude (orientation) of the virtual camera. However, unlimited to this, the camera parameters may include, for example, a parameter indicating the angle of view of the virtual camera. The virtual camera operator is allowed to control the position and orientation of the virtual camera using an operation unit such as a joy stick, and can control the angle of view of the virtual camera using an operation unit such as a slider. Additionally, the virtual camera operator may control the virtual camera by directly designating virtual camera parameters using an operation unit such as a touch panel or a keyboard. Furthermore, the virtual camera operation unit 102 notifies the virtual camera switching section control unit 106 of a request for switching between the actual camera and the virtual camera and the execution of the switching. Here, the actual camera is a broadcast camera, a drone camera, a multi-viewpoint image-capturing camera, or the like, and the actual camera image is an image captured by the actual camera. Also, the switching request is a request for switching from an actual camera image to a virtual camera image or switching from a virtual camera image to an actual camera image, and is instructed by a director or the like. The switching request notification is performed in the case where the virtual camera operator who has received the instruction by the director or the like via the microphone headset or the like inputs the switching request via the operation unit (for example, pressing a button displayed on the touch panel screen). In addition, the switching execution notification is performed in the case where the virtual camera operator who has confirmed the execution of switching according to the switching request by the image switching unit 30 inputs the switching execution via the operation unit (for example, pressing a button displayed on the touch panel). In addition, the virtual camera operation unit 102 passes the virtual camera parameters to the virtual camera switching section control unit 106.

The virtual camera path generation unit 103 receives virtual camera parameters from the virtual camera operation unit 102 or the virtual camera switching section control unit 106, generates a virtual camera path, and passes the virtual camera path to the virtual viewpoint image generation unit 104. Here, the virtual camera path is represented by temporally continuous virtual camera parameters. In the case of generating a virtual camera path, the virtual camera path generation unit 103 associates each parameter with a frame number or a time code so as to identify which frame is related to the parameter. The virtual camera path generation unit 103 receives the automatic operation mode from the virtual camera switching section control unit 106, and generates a virtual camera path using the virtual camera parameters from the virtual camera switching section control unit 106 if the automatic operation mode on. The virtual camera path generation unit 103 generates a virtual camera path using the virtual camera parameters from the virtual camera operation unit 102 if the automatic operation mode is off. The automatic operation mode is a mode in which the virtual camera path generation unit 103 generates a virtual camera path according to the virtual camera parameters from the virtual camera switching section control unit 106 and automatically operates the virtual camera in the switching section.

The virtual viewpoint image generation unit 104 generates a three-dimensional model from the multi-viewpoint images captured by the multi-viewpoint image capturing unit 101. Then, a virtual viewpoint image is generated by mapping a texture at a virtual viewpoint in the virtual camera path generated by the virtual camera path generation unit 103 (that is, the position, orientation, and angle of view of the virtual camera). The virtual viewpoint image generation unit 104 passes the generated virtual viewpoint image to the switching support information presentation unit 107 and the image switching unit 30.

The actual camera information obtaining unit 105 obtains information on an actual camera (hereinafter, also referred to as actual camera information) from the actual camera image capturing unit 20 and passes the information to the virtual camera switching section control unit 106. Here, the actual camera information includes at least information indicating the position and attitude (orientation) of the actual camera. However, unlimited to this, the actual camera information may include information indicating the angle of view of the actual camera.

The virtual camera switching section control unit 106 controls the virtual camera based on the actual camera information received from the actual camera information obtaining unit 105 and on the virtual camera parameters, the switching request notification, and the switching execution notification received from the virtual camera operation unit 102. Here, the switching section is a section from the reception of the switching request notification to the turning off of the automatic operation mode. The virtual camera switching section control unit 106 passes the control results as virtual camera parameters to the virtual camera path generation unit 103. The virtual camera switching section control unit 106 passes the automatic operation mode to the virtual camera path generation unit 103. The virtual camera switching section control unit 106 instructs the switching support information presentation unit 107 to present switching support information, and notifies the switching status. Description is provided later for the details of the virtual camera switching section control unit 106.

Based on the switching support information presentation instruction from the virtual camera switching section control unit 106, the switching support information presentation unit 107 creates a switching support screen, and presents it on an operation screen (not illustrated) of an actual camera operator, a virtual camera operator, or both. The switching support information presentation unit 107 obtains the virtual viewpoint image from the virtual viewpoint image generation unit 104 and the actual camera image from the actual camera image capturing unit 20. Description is provided later for the details of the switching support information presentation unit 107.

The actual camera image capturing unit 20 is a camera or the like of a broadcasting station arranged at, for example, the side of the competition field to be captured. The position, orientation, and angle of view of the actual camera are controlled by the actual camera operator, and the captured image is passed to the image switching unit 30 and the switching support information presentation unit 107. The actual camera image capturing unit 20 includes measuring instruments such as a GPS receiver and a gyro sensor, and identifies the position and orientation of the actual camera. In addition, the actual camera image capturing unit 20 identifies the angle of view of the actual camera based on the zoom state. In addition, the actual camera image capturing unit 20 passes the position, orientation, and angle of view of the actual camera as actual camera information to the actual camera information obtaining unit 105. The number of the actual camera image capturing units 20 may be plural as long as individual actual camera image capturing units 20 can be distinguished. Note that the actual camera image capturing unit 20 may be a part of a plurality of cameras constituting the multi-viewpoint image capturing unit 101.

After selecting one image from a plurality of images including at least the virtual viewpoint images from the virtual viewpoint image generation unit 104 and the actual camera images from the actual camera image capturing unit 20, the image switching unit 30 passes that image to a not-illustrated broadcasting facility or webcasting server. Specifically, the image switching unit 30 switches the image presented to the viewer between the actual camera image and the virtual viewpoint image. Here, the image is selected by the switcher that has received the instruction by the director or the like via the microphone headset or the like.

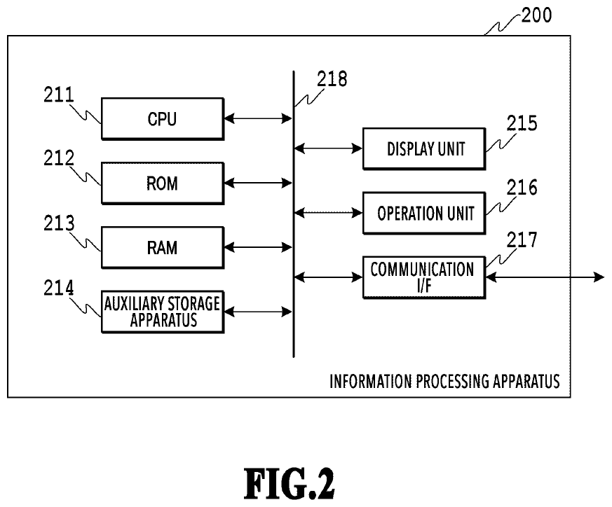

FIG. 2 illustrates a hardware configuration of an information processing apparatus 200 operable as the image processing apparatus 10. The information processing apparatus 200 includes a CPU 211, a ROM 212, a RAM 213, an auxiliary storage apparatus 214, a display unit 215, an operation unit 216, a communication interface (I/F) 217, and a bus 218.

The CPU 211 provides the functions indicated in FIG. 1 by controlling the entire information processing apparatus 200 by use of computer programs and data stored in the ROM 212 and the RAM 213. Note that the information processing apparatus 200 may include one or more pieces of dedicated hardware different from the CPU 211, and at least a part of the processing by the CPU 211 may be executed by the dedicated hardware. Examples of the dedicated hardware include application specific integrated circuits (ASICs), field programmable gate arrays (FPGAs), and digital signal processors (DSPs). The ROM 212 stores programs that do not need to be altered. The RAM 213 temporarily stores programs and data supplied from the auxiliary storage apparatus 214, data supplied from the outside via the communication I/F 217, and the like. The auxiliary storage apparatus 214 includes, for example, a hard disk drive and stores various data such as image data and audio data.

The display unit 215 includes, for example, a liquid crystal display or an LED, and displays a graphical user interface (GUI) for the user to operate the information processing apparatus 200. The operation unit 216 includes, for example, a keyboard, a mouse, a joy stick, a touch panel, and the like, and inputs various instructions to the CPU 211 in response to an operation by the user. The communication I/F 217 is used for communication with an apparatus external to the information processing apparatus 200. For example, in the case where the information processing apparatus 200 is connected to an external apparatus in a wired manner, a communication cable is connected to the communication I/F 217. In the case where the information processing apparatus 200 has a function of performing wireless communication with an external apparatus, the communication I/F 217 includes an antenna. The bus 218 connects the units of the information processing apparatus 200 to transmit information.

In the present embodiment, description is provided assuming that the display unit 215 and the operation unit 216 are present inside the information processing apparatus 200. However, at least one of the display unit 215 and the operation unit 216 may be present as another apparatus outside the information processing apparatus 200. In this case, the CPU 211 may operate as a display control unit that controls the display unit 215 and as an operation control unit that controls the operation unit 216.

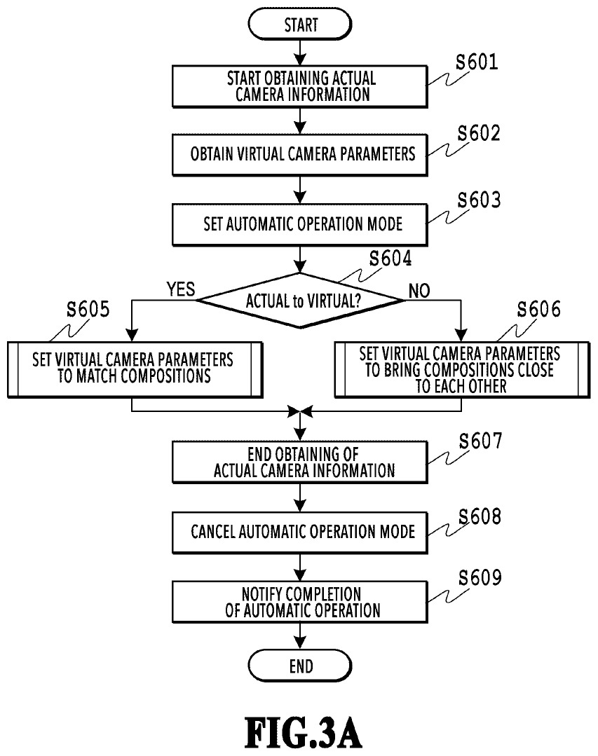

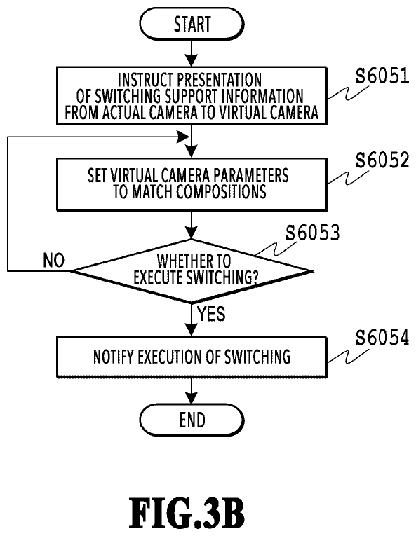

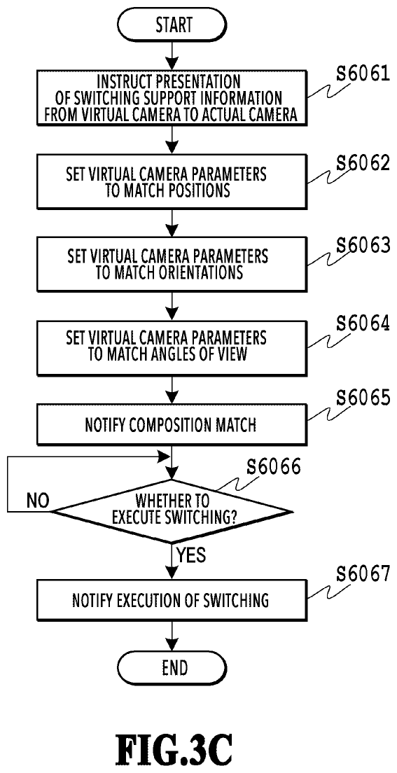

FIGS. 3A, 3B, and 3C each provide a processing flowchart of switching section control by the virtual camera switching section control unit 106. Here, first, description is provided for an overall processing flow of the switching section control with reference to FIG. 3A. The symbol “S” below means “step” in the flowchart. The same applies to other flowcharts.

Upon receiving the switching request notification from the virtual camera operation unit 102, the virtual camera switching section control unit 106 starts the switching section control processing. If the image switching unit 30 at the time of receiving the switching request notification selects the actual camera image, the switching is from the actual camera image to the virtual camera image. If the virtual camera image is selected, the switching is from the virtual camera image to the actual camera image.

First, the virtual camera switching section control unit 106 starts obtaining actual camera information (that is, the position, orientation, and angle of view of the actual camera) from the actual camera information obtaining unit 105 (S601). The actual camera information may be continuously obtained on a regular basis from the actual camera information obtaining unit 105, or may be obtained only at the time of update by causing the actual camera information obtaining unit 105 to notify the virtual camera switching section control unit 106 of the update of the actual camera information. In addition, in the switching from the virtual camera to the actual camera in the case where there are a plurality of actual cameras, an actual camera ID may be included in the switching request notification so as to select a specific actual camera or to specify the actual camera closest to the virtual camera. Next, the virtual camera switching section control unit 106 obtains virtual camera parameters from the virtual camera operation unit 102 (S602). Note that the processing order of S601 and S602 may be any order.

Next, the virtual camera switching section control unit 106 turns on the automatic operation mode and passes it to the virtual camera path generation unit 103 (S603). Specifically, the virtual camera path generation unit 103 is set to generate a virtual camera path according to the virtual camera parameters from the virtual camera switching section control unit 106 and to automatically manipulate the virtual camera.

If the switching is from the actual camera image to the virtual camera image (yes in S604), the virtual camera switching section control unit 106 sets the virtual camera parameters so that the composition of the virtual camera image (the position, orientation, and angle of view of the virtual camera) matches the composition of the actual camera image (the position, orientation, and angle of view of the actual camera) (S605). That is, since the actual camera image is displayed before the switching, the composition of the virtual camera image is matched with the composition of the actual camera image before the switching.

Meanwhile, if the switching is from the virtual camera image to the actual camera image (no in S604), the virtual camera switching section control unit 106 sets the virtual camera parameters so that the composition of the virtual camera image gradually approaches the composition of the actual camera image (S606). That is, the composition of the virtual camera image selected before the switching is made to gradually approach and match the composition of the actual camera image.

Note that description is provided later for the details of the virtual camera parameter setting processing in S605 and S606 with reference to FIG. 3B and FIG. 3C, respectively.

Next, the virtual camera switching section control unit 106 ends the obtaining of the actual camera information (S607), turns off the automatic operation mode to pass it to the virtual camera path generation unit 103 (S608). After the automatic operation mode is turned off, the virtual camera path generation unit 103 can generate a virtual camera path using the virtual camera parameters from the virtual camera operation unit 102. Moreover, the virtual camera switching section control unit 106 notifies the switching support information presentation unit 107 that the automatic operation has been completed (S609), and ends the switching section control processing.

FIG. 3B is a processing flowchart of virtual camera parameter setting (S605 in FIG. 3A) in switching from the actual camera image to the virtual camera image by the virtual camera switching section control unit 106.

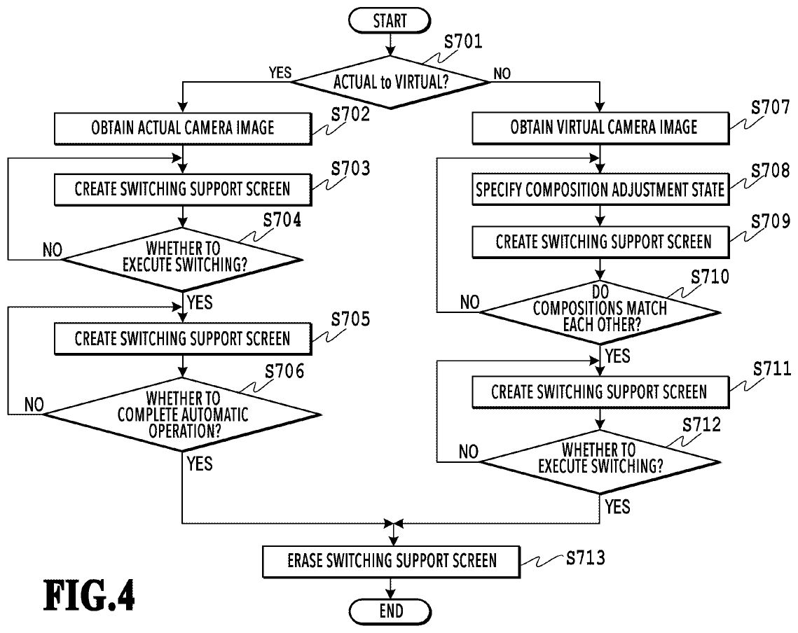

First, the virtual camera switching section control unit 106 instructs the switching support information presentation unit 107 to present switching support information from the actual camera to the virtual camera (S6051). The switching support information presentation processing by the switching support information presentation unit 107 is described later with reference to FIG. 4.

Next, the virtual camera switching section control unit 106 passes the position, orientation, and angle of view of the actual camera as virtual camera parameters to the virtual camera path generation unit 103 (S6052). As a result, the virtual camera parameters generated by the virtual camera path generation unit 103 have the same position, orientation, and angle of view as the actual camera. Therefore, the composition of the actual camera before the switching and the composition of the virtual camera after the switching are the same. The virtual camera switching section control unit 106 continues setting the virtual camera parameters (S6052) while not receiving the switching execution notification from the virtual camera operation unit 102 (no in S6053). Upon receiving the switching execution notification from the virtual camera operation unit 102 (yes in S6053), the virtual camera switching section control unit 106 notifies the switching support information presentation unit 107 of the switching execution (S6054), and ends the virtual camera parameter setting processing.

FIG. 3C is a processing flowchart of virtual camera parameter setting (S606 in FIG. 3A) in switching from the virtual camera image to the actual camera image by the virtual camera switching section control unit 106.

First, the virtual camera switching section control unit 106 instructs the switching support information presentation unit 107 to present switching support information from the virtual camera to the actual camera (S6061). The switching support information presentation processing by the switching support information presentation unit 107 is described later with reference to FIG. 4.

Next, the virtual camera switching section control unit 106 sets the virtual camera parameters based on the actual camera information and the virtual camera parameters so that the position of the virtual camera gradually approaches and matches the position of the actual camera (S6062). If the difference in position between the virtual camera and the actual camera is larger than a predetermined threshold, a plurality of virtual camera parameters that gradually change from the virtual camera position to the actual camera position is obtained and passed to the virtual camera path generation unit 103. In addition, the virtual camera switching section control unit 106 sets the virtual camera parameters based on the actual camera information and the virtual camera parameters so that the orientation of the virtual camera gradually approaches and matches the orientation of the actual camera (S6063). If the difference in orientation between the virtual camera and the actual camera is larger than a predetermined threshold, a plurality of virtual camera parameters that gradually change from the virtual camera orientation to the actual camera orientation is obtained and passed to the virtual camera path generation unit 103. In addition, the virtual camera switching section control unit 106 sets the virtual camera parameters based on the actual camera information and the virtual camera parameters so that the angle of view of the virtual camera gradually approaches and matches the angle of view of the actual camera (S6064). If the difference in angle of view between the virtual camera and the actual camera is larger than a predetermined threshold, a plurality of virtual camera parameters that gradually change from the virtual camera viewing angle to the actual camera viewing angle is obtained and passed to the virtual camera path generation unit 103. Note that the position adjustment (S6062), orientation adjustment (S6063), and viewing angle adjustment (S6064) may be performed in different orders, two of the adjustments may be performed collectively, such as performing position adjustment and viewing angle adjustment simultaneously, or the three adjustments may be performed collectively.

Next, the virtual camera switching section control unit 106 notifies the switching support information presentation unit 107 that the compositions of the virtual camera image and the actual camera image have matched each other (S6065).

Upon receiving the switching execution notification from the virtual camera operation unit 102 (yes in S6066), the virtual camera switching section control unit 106 notifies the switching support information presentation unit 107 that the switching has been executed (S6067), and ends the virtual camera parameter setting processing.

FIG. 4 is a processing flowchart of switching support information presentation by the switching support information presentation unit 107. Upon being instructed to present switching support information by the virtual camera switching section control unit 106 (S6051 in FIG. 3B and S6061 in FIG. 3C), the switching support information presentation unit 107 starts the switching support information presentation processing.

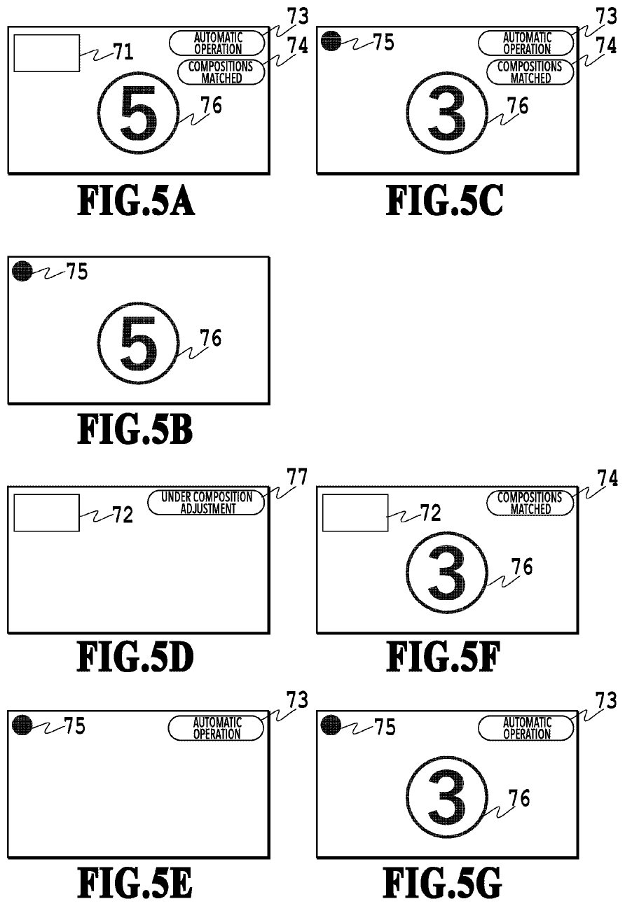

If the received instruction is presentation of switching support information from the actual camera to the virtual camera (yes in S701), the switching support information presentation unit 107 first obtains the actual camera image (that is, the image of the switching source) from the actual camera image capturing unit 20 (S702). Then, a switching support screen before the switching is created based on the virtual camera image matched with the composition of the actual camera image (S703). The switching support screen created in S703 is presented on the operation screen of the virtual camera operator, and includes at least an actual camera image 71, a notification 73 indicating that automatic operation is being performed, and a notification 74 indicating that the compositions are matched, as illustrated in the example of FIG. 5A. The virtual camera image of the switching destination may also be displayed on the operation screen. If the time until the switching from the actual camera to the virtual camera is known by, for example, a director's verbal instruction of “switch in five seconds,” the remaining time 76 may be presented while counting down. In addition, in S703, the switching support information presentation unit 107 may further create a screen to be presented on the operation screen of the actual camera operator as illustrated in the example of FIG. 5B. This screen may include a notification 75 indicating that the image switching unit 30 currently selects the image (that is, the actual camera image being the switching source image). The notification 75 allows the actual camera operator to learn that the actual camera image is currently selected.

Next, upon receiving the switching execution notification from the virtual camera switching section control unit 106 (yes in S704), the switching support information presentation unit 107 creates a switching support screen after switching (S705). Note that, in the case of switching from the actual camera to the virtual camera, the automatic operation mode is continued even after the switching (that is, the switching section is continued). The switching support screen created in S705 is presented on the operation screen of the virtual camera operator, and includes at least a notification 73 indicating that automatic operation is being performed and a notification 74 indicating that the compositions are matched, as illustrated in the example of FIG. 5C. In addition, the image switching unit 30 may further include a notification 75 indicating that the virtual camera image is being selected. If the time from the switching to the image of the virtual camera to the completion of the automatic operation is known by a fixed value or the like, the remaining time 76 may be presented while counting down.

Next, upon receiving an automatic operation completion notification (that is, a notification that the automatic operation mode has been turned off) from the virtual camera switching section control unit 106 (yes in S706), the switching support information presentation unit 107 erases the switching support screen (S713), and ends the switching support information presentation processing.

Back to the explanation of S701, if the instruction received from the virtual camera switching section control unit 106 is presentation of switching support information from the virtual camera to the actual camera (no in S701), the switching support information presentation unit 107 obtains a virtual camera image from the virtual viewpoint image generation unit 104 (S707). That is, the switching support information presentation unit 107 obtains a virtual camera image as the image of the switching source.

Next, the switching support information presentation unit 107 specifies the composition adjustment state (S708), and creates a switching support screen before composition match (S709). Here, the composition adjustment state is a state in which the position, orientation, and angle of view of the virtual camera are adjusted by the virtual camera switching section control unit 106 to bring the compositions of the virtual camera and the actual camera close to each other (S6062 to S6064 in FIG. 3C). The switching support screen created in S709 is presented on the operation screen of the actual camera operator, and includes at least the virtual camera image 72 and the composition adjustment state 77, as illustrated in the example of FIG. 5D. The actual camera image of the switching destination may also be displayed on the operation screen. This switching support screen shows that the composition of the virtual camera image gradually approaches the composition of the actual camera image. In addition, in S709, the switching support information presentation unit 107 may further create a screen to be presented on the operation screen of the virtual camera operator as illustrated in the example of FIG. 5E. This screen may include a notification 75 indicating that the image switching unit 30 is selecting the image (that is, the virtual camera image being the switching source image). The notification 75 allows the virtual camera operator to learn that the virtual camera image is currently selected. In addition, this screen may further include a notification 73 indicating that the automatic operation is being performed.

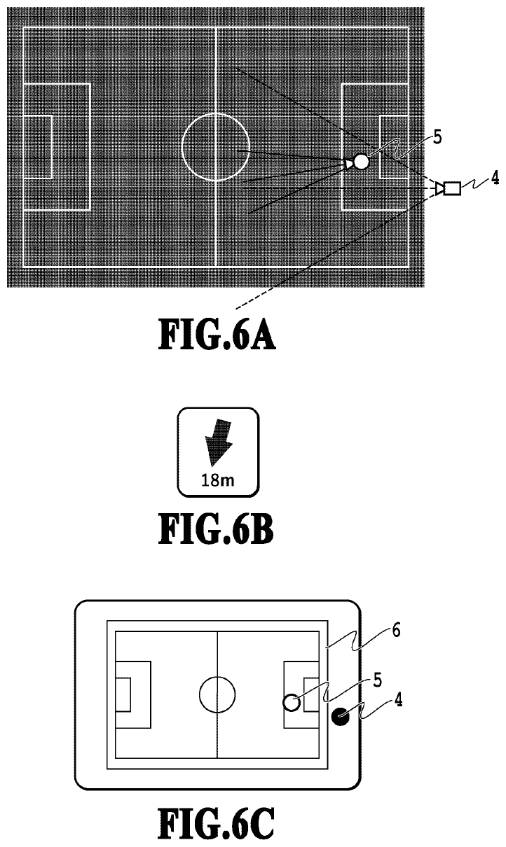

While not receiving the composition match notification from the virtual camera switching section control unit 106 (no in S710), the switching support information presentation unit 107 continues to specify the composition adjustment state (S708) and create the switching support screen before composition match (S709). The information displayed on the switching support screen may be a notification that the composition is being adjusted as illustrated in FIG. 5D, or may be an illustration of the relationship between the actual camera and the virtual camera as illustrated in FIGS. 6A, 6B, and 6C. For example, if the positional relationship between the actual camera 4 and the virtual camera 5 is as illustrated in FIG. 6A, the relative position of the virtual camera 5 from the actual camera 4 (here, approaching slightly from the right in front of the actual camera at a distance of 18 m) may be illustrated as in FIG. 6B. In addition, as in FIG. 6C, the absolute positions of the actual camera 4 and the virtual camera 5 may be plotted (superimposed) on the overhead view map 6 of the capturing area. The information illustrated in FIG. 6B and FIG. 6C is an example of information indicating the degree of match between the position of the virtual camera and the position of the actual camera.

Upon receiving the composition match notification from the virtual camera switching section control unit 106 (yes in S710), the switching support information presentation unit 107 creates a switching support screen after composition match (S711). The switching support screen created in S711 is presented on the operation screen of the actual camera operator, and includes at least the virtual camera image 72 and a notification 74 indicating that the compositions have matched each other, as illustrated in the example of FIG. 5F. If the time from composition match to switching is known by a fixed value or the like, the remaining time 76 may be presented while counting down. In addition, in S711, the switching support information presentation unit 107 may further create a screen to be presented to the virtual camera operator as illustrated in the example of FIG. 5G. This screen may include a notification 75 indicating that the image switching unit 30 is selecting the image (that is, the virtual camera image being the switching source image) and a notification 73 indicating that the automatic operation is being performed. Moreover, the remaining time 76 may be presented while counting down.

Next, upon receiving the switching execution notification from the virtual camera switching section control unit 106 (yes in S712), the switching support information presentation unit 107 erases the switching support screen (S713), and ends the switching support information presentation processing.

As described above, according to the present embodiment, the virtual camera can be automatically controlled so that the compositions of the actual camera image and the virtual camera image are matched, and meanwhile the camera image and the composition adjustment state can be presented to the camera operator. By doing so, the camera operator is allowed to grasp a movement of the camera before composition match or before switching. Since the camera operator is allowed to take over the movement of the camera before switching, it is possible to switch between the actual camera image and the virtual camera image without greatly changing the movement of the camera before and after switching. That is, it is possible to assist the camera operator to operate the camera so as not to give a discontinuous impression to the viewer before and after the switching of the image.

### Second Embodiment

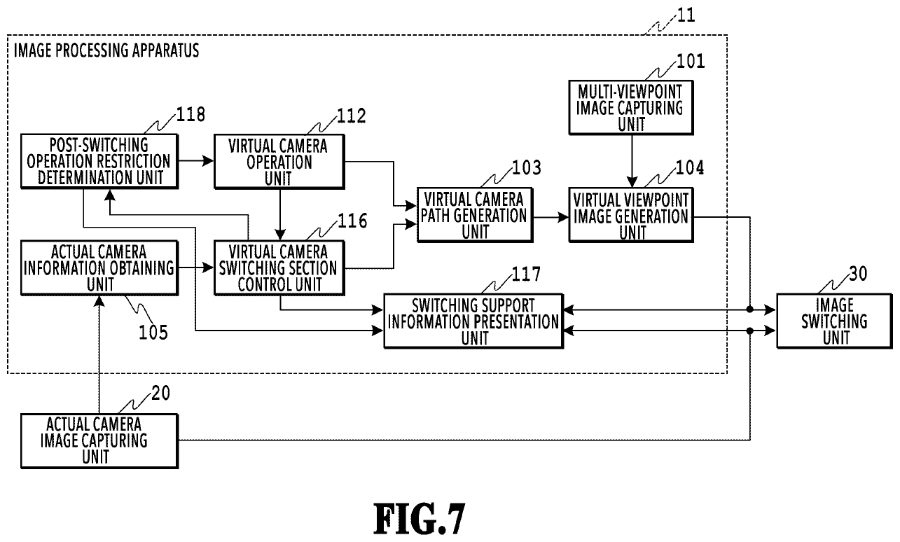

FIG. 7 is an overall configuration diagram of an image processing system to which the second embodiment of the present invention is applied.

The image processing apparatus 11 includes a multi-viewpoint image capturing unit 101, a virtual camera operation unit 112, a virtual camera path generation unit 103, a virtual viewpoint image generation unit 104, and an actual camera information obtaining unit 105. Also, the image processing apparatus 11 includes a virtual camera switching section control unit 116, a switching support information presentation unit 117, and a post-switching operation restriction determination unit 118.

Explanation is omitted for the multi-viewpoint image capturing unit 101, the virtual camera path generation unit 103, the virtual viewpoint image generation unit 104, and the actual camera information obtaining unit 105 because they are the same as those in FIG. 1.

The virtual camera operation unit 112 performs virtual camera control by the virtual camera operator and the post-switching operation restriction determination unit 118, and passes the control results as virtual camera parameters to the virtual camera path generation unit 103. The virtual camera operation unit 112 passes the switching request notification, the switching execution notification, and the virtual camera parameter to the virtual camera switching section control unit 116.

The virtual camera switching section control unit 116 controls the virtual camera based on the actual camera information from the actual camera information obtaining unit 105, the virtual camera parameters from the virtual camera operation unit 112, the switching request notification, and the switching execution notification. The virtual camera switching section control unit 116 passes the virtual camera parameters and the automatic operation mode as the control results to the virtual camera path generation unit 103 as well as instructs the switching support information presentation unit 117 to present the switching support information, and notifies the switching status. In addition, the virtual camera switching section control unit 116 passes the details of automatic operation to the post-switching operation restriction determination unit 118. Description is provided later for the details of the virtual camera switching section control unit 116.

The switching support information presentation unit 117 creates and presents the switching support screen based on the switching status notification from the virtual camera switching section control unit 116, the virtual viewpoint image from the virtual viewpoint image generation unit 104, and the actual camera image from the actual camera image capturing unit 20. In addition, the switching support information presentation unit 117 receives post-switching operation restriction information (that is, the details of operation restriction to be described later) on the actual camera from the post-switching operation restriction determination unit 118, and creates a switching support screen and presents it to the actual camera operator.

Based on the details of automatic operation from the virtual camera switching section control unit 116, the post-switching operation restriction determination unit 118 determines the details of post-switching operation restriction, and passes it to the virtual camera operation unit 112 and/or the switching support information presentation unit 117. Description is provided later for the details of the post-switching operation restriction determination unit 118.

Explanation is omitted for the actual camera image capturing unit 20 and the image switching unit 30 because they are the same as those in FIG. 1.

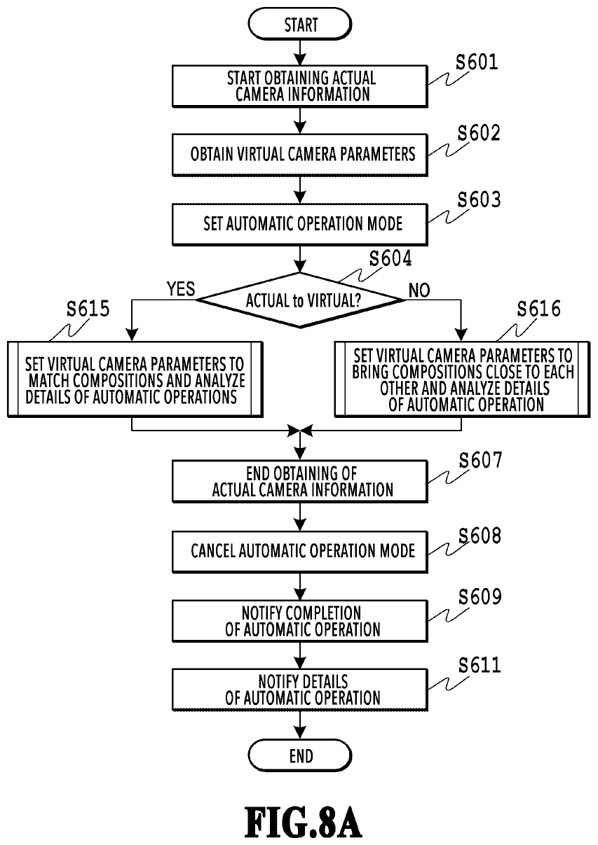

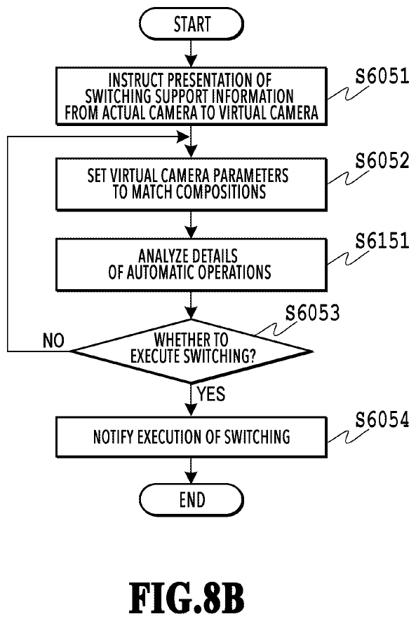

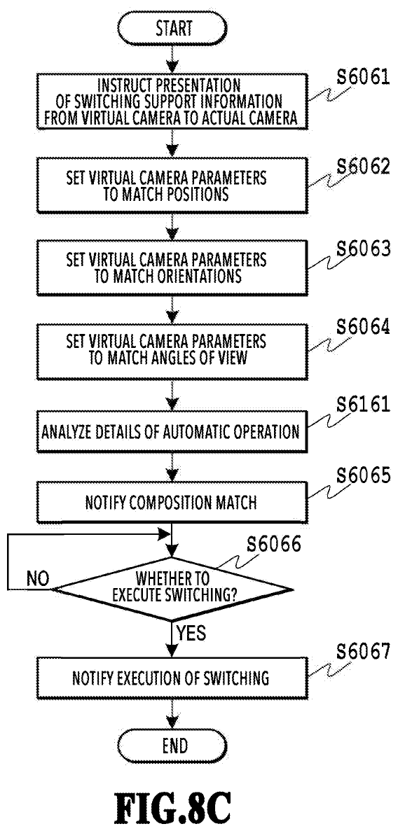

FIGS. 8A, 8B, and 8C each provide a processing flowchart of switching section control by the virtual camera switching section control unit 116. Here, first, description is provided for an overall processing flow of the switching section control with reference to FIG. 8A. Note that the same processes as those in FIG. 3A are denoted by the same reference numerals, and detailed description thereof is omitted.

Upon receiving the switching request notification from the virtual camera operation unit 112, the virtual camera switching section control unit 116 starts the switching section control processing.

First, the virtual camera switching section control unit 116 starts obtaining actual camera information from the actual camera information obtaining unit 105 (S601). Next, the virtual camera switching section control unit 116 obtains virtual camera parameters from the virtual camera operation unit 112 (S602), and turns on the automatic operation mode and passes it to the virtual camera path generation unit 103 (S603).

If the switching is from the actual camera image to the virtual camera image (yes in S604), the virtual camera switching section control unit 116 sets the virtual camera parameters so that the composition of the virtual camera image matches the composition of the actual camera image, and analyzes the details of automatic operation (S615).

Meanwhile, if the switching is from the virtual camera image to the actual camera image (no in S604), the virtual camera switching section control unit 116 sets the virtual camera parameters so that the composition of the virtual camera image gradually approaches the composition of the actual camera image, and analyzes the details of automatic operation (S616).

Note that description is provided later for the details of the virtual camera parameter setting processing and the automatic operation detail analysis processing in S615 and S616 with reference to FIG. 8B and FIG. 8C, respectively.

Next, the virtual camera switching section control unit 116 ends the obtaining of the actual camera information (S607), turns off the automatic operation mode to pass it to the virtual camera path generation unit 103 (S608), and notifies the switching support information presentation unit 107 that the automatic operation has been completed (S609). Next, the virtual camera switching section control unit 116 notifies the post-switching operation restriction determination unit 118 of the analyzed details of automatic operation (that is, the details of controlling the virtual camera) (S611), and ends the switching section control processing.

FIG. 8B is a processing flowchart of virtual camera parameter setting and analysis (S615 in FIG. 8A) in switching from the actual camera image to the virtual camera image by the virtual camera switching section control unit 116. The same processes as those in FIG. 3B are denoted by the same reference numerals, and detailed description thereof is omitted.

First, the virtual camera switching section control unit 116 instructs the switching support information presentation unit 107 to present switching support information from the actual camera to the virtual camera (S6051). Next, the virtual camera switching section control unit 116 passes the position, orientation, and angle of view of the actual camera as virtual camera parameters to the virtual camera path generation unit 103 (S6052). Next, the virtual camera switching section control unit 116 analyzes the details of automatic operation from the virtual camera parameters (S6151).

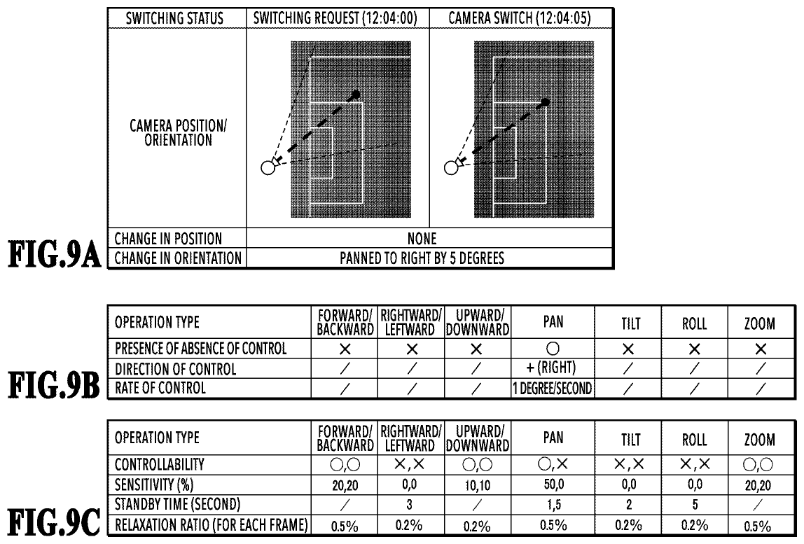

The virtual camera switching section control unit 116 continues setting the virtual camera parameters (S6052) and analyzing the details of automatic operation (S6151) while not receiving the switching execution notification from the virtual camera operation unit 112 (no in S6053). Here, since the virtual camera parameters set in S6052 correspond to actual camera operations before the execution of switching, the details of automatic operation analyzed in S6151 also correspond to actual camera operations before the execution of switching. Assume that the virtual camera position automatically controlled so that the composition is matched with that of the actual camera image is the example illustrated in FIG. 9A. This means that, during the five seconds from the reception of the switching request to the execution of switching, the camera position does not change and the camera direction has panned to the right five times. Therefore, the operation of position (forward/backward, rightward/leftward, and upward/downward), operation of orientation (pan, tilt, and roll), and operation of angle of view (zoom) of the virtual camera by automatic control is analyzed such that there is no operation of position, there is operation of orientation (panning rightward at a rate of 1 degree/second), and there is no operation of angle of view, as illustrated in FIG. 9B. Note that the details of automatic operation may be analyzed not based on the entire section from the reception of the switching request to the execution of switching but based on the virtual camera parameters in the section for the latest predetermined frames derived from the latest virtual camera parameters set in S6052.

Upon receiving the switching execution notification from the virtual camera operation unit 112 (yes in S6053), the virtual camera switching section control unit 116 notifies the switching support information presentation unit 107 that the switching has been executed (S6054), and ends the virtual camera parameter setting processing.

FIG. 8C is a processing flowchart of virtual camera parameter setting and analysis (S616 in FIG. 8A) in switching from the virtual camera image to the actual camera image by the virtual camera switching section control unit 116. The same processes as those in FIG. 3C are denoted by the same reference numerals, and detailed description thereof is omitted.

First, the virtual camera switching section control unit 116 instructs the switching support information presentation unit 117 to present switching support information from the virtual camera to the actual camera (S6061). Next, the virtual camera switching section control unit 116 sets the virtual camera parameters based on the actual camera information and the virtual camera parameters so that the position, orientation, and angle of view of the virtual camera gradually approaches and matches the position, orientation, and angle of view of the actual camera (S6062 to S6064). The virtual camera switching section control unit 116 analyzes the details of automatic operation from the virtual camera parameters set in S6062 to S6064 from the reception of the switching request notification until the compositions match (S6161).

Next, the virtual camera switching section control unit 116 notifies the switching support information presentation unit 117 that the compositions of the virtual camera image and the actual camera image have matched each other (S6065), and waits for the execution of switching (S6066). Upon receiving the switching execution notification from the virtual camera operation unit 112 (yes in S6066), the virtual camera switching section control unit 116 notifies the switching support information presentation unit 107 that the switching has been executed (S6067), and ends the virtual camera parameter setting processing.

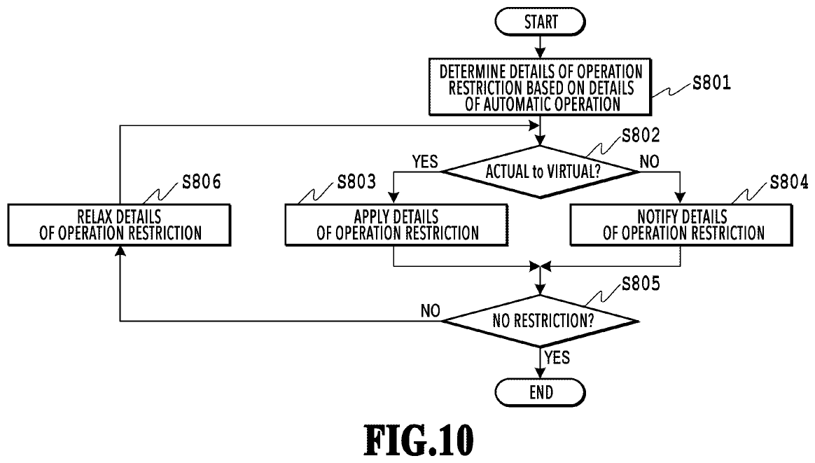

FIG. 10 is a processing flowchart of determining the details of post-switching operation restriction by the post-switching operation restriction determination unit 118. Upon receiving the analyzed details of automatic operation from the virtual camera switching section control unit 116 (S611 in FIG. 8A), the post-switching operation restriction determination unit 118 starts the processing of determining the details of post-switching operation restriction.

Based on the received details of automatic operation (that is, the details of controlling the virtual camera), the post-switching operation restriction determination unit 118 determines the details of post-switching operation restriction (S801). Here, the post-switching operation restriction is an operation restriction for suppressing a large change in the details of operation before and after the switching, and restricts, for a while after the switching, the operations other than continuing the pre-switching operation or maintaining the main subject. FIG. 9B illustrates an example of the details of automatic operation, and FIG. 9C illustrates an example of the details of operation restriction. If the received details of automatic operation are those illustrated in FIG. 9B, the operation of continuing the pre-switching operation is a pan operation to the right, and the operation of maintaining the main subject is a forward/backward movement, a zoom, or an upward/downward movement with automatic tilt, as illustrated in the controllability list of FIG. 9C. In addition, as illustrated in the sensitivity list of FIG. 9C, the operation sensitivity of a joy stick or the like may be restricted so that the pan speed, the forward/backward movement, and the zoom speed do not change abruptly compared to those before the switching. Here, the initial value of the operation sensitivity may be uniquely determined depending on controllability, or may be assigned according to the priority of the control-enabled operation. The details of operation restriction include at least one of the operation of position (forward/backward, rightward/leftward, and upward/downward), operation of orientation (pan, tilt, and roll), and operation of angle of view (zoom).

If the switching is from the actual camera image to the virtual camera image (yes in S802), the post-switching operation restriction determination unit 118 passes the details of operation restriction to the virtual camera operation unit 112 (S803). That is, the operation by the virtual camera operation unit 112 is restricted according to the details of operation restriction. Meanwhile, if the switching is from the virtual camera image to the actual camera image (no in S802), the details of operation restriction are passed to the switching support information presentation unit 117 (S804). That is, the switching support information by the switching support information presentation unit 117 is presented according to the details of operation restriction.

Next, if the operation restriction has not been done away with (no in S805), the post-switching operation restriction determination unit 118 relaxes the details of the operation restriction step by step (S806). Here, the relaxation of the details of operation restriction refers to enabling the disabled operation or increasing the operation sensitivity in order to gradually release the restrictions as time elapses so as to eliminate the restrictions. As indicated in the standby time list and the relaxation ratio list in the details of operation restriction of FIG. 9C, the details of operation restriction are relaxed step by step based on the time until the operation is enabled and on the degree of increasing the operation sensitivity. Here, the values of the standby time and the relaxation ratio may be uniquely determined for each operation type, or may be assigned according to the initial value of the sensitivity. In addition, the relaxation ratio may be increased exponentially, instead of being increased linearly as illustrated in FIG. 9C. If the operation restriction has been done away with due to the relaxation of the details of operation restriction (yes in S805), the post-switching operation restriction determination unit 118 ends the processing of determining the details of post-switching operation restriction.

As described above, according to the present embodiment, the operation of the camera after switching can be restricted according to the details of automatic operation of the camera before switching. By doing so, it is possible to restrict the operation of the virtual camera so that the operation of the camera after switching does not greatly change from the operation of the camera before switching, or to present the details of operation of the actual camera to the operator. Since the camera operator is allowed to move the camera after switching without abruptly changing the way to move the camera before switching, it is possible to switch between the actual camera image and the virtual camera image without greatly changing the way to move the camera before and after switching.

### Third Embodiment

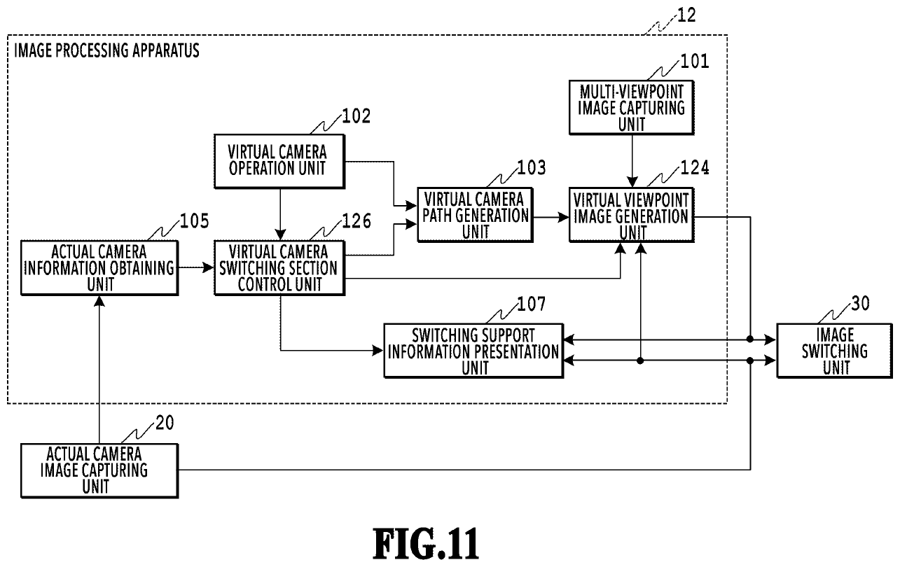

FIG. 11 is an overall configuration diagram of an image processing system to which the third embodiment of the present invention is applied.

The image processing apparatus 12 includes a multi-viewpoint image capturing unit 101, a virtual camera operation unit 102, a virtual camera path generation unit 103, a virtual viewpoint image generation unit 124, an actual camera information obtaining unit 105, a virtual camera switching section control unit 126, and a switching support information presentation unit 107.

Explanation is omitted for the multi-viewpoint image capturing unit 101, the virtual camera operation unit 102, the virtual camera path generation unit 103, the actual camera information obtaining unit 105, and the switching support information presentation unit 107 because they are the same as those in FIG. 1.

The virtual viewpoint image generation unit 124 crates a virtual viewpoint image based on the multi-viewpoint images from the multi-viewpoint image capturing unit 101 and the virtual camera parameters from the virtual camera path generation unit 103, and passes it to the switching support information presentation unit 107 and the image switching unit 30. In the case of receiving from the virtual camera switching section control unit 126 the instructions for reducing the difference from the actual camera and the difference reduction conditions, the virtual viewpoint image generation unit 124 performs difference reduction processing by use of the generated virtual viewpoint image and the actual camera image received from the actual camera image capturing unit 20. Here, the difference from the actual camera is, for example, a difference in image quality in terms of resolution and color reproduction. In addition, the difference reduction processing refers to, for example, the process of blending an actual camera image and a virtual camera image having the same composition. In addition, the difference reduction conditions include at least a switching direction whether to switch from the actual camera to the virtual camera or to switch from the virtual camera to the actual camera. The virtual viewpoint image generation unit 124 reduces stepwise the ratio of blending the actual camera image in the case of switching from the actual camera to the virtual camera, and increases stepwise the ratio of blending the actual camera image in the case of switching from the virtual camera to the actual camera, thereby reducing the difference in image quality from the actual camera.

The virtual camera switching section control unit 126 controls the virtual camera in the switching section based on the actual camera information from the actual camera information obtaining unit 105, the virtual camera parameters from the virtual camera operation unit 102, the switching request notification, and the switching execution notification. The virtual camera switching section control unit 126 passes the virtual camera parameters and the automatic operation mode to the virtual camera path generation unit 103, instructs the switching support information presentation unit 107 to present switching support information, and notifies the switching status. If the compositions of the actual camera image and the virtual camera image match each other, the virtual camera switching section control unit 126 instructs the virtual viewpoint image generation unit 124 to reduce the difference by passing the difference reduction conditions.

As described above, the present embodiment automatically controls the virtual camera so that the compositions of the actual camera image and the virtual camera image match each other, and then reduces the difference in image quality between the virtual camera image and the actual camera image. By doing so, it is possible to continuously switch not only the composition but also the image quality.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The above-described embodiments make it possible to improve the continuity of image before and after switching between the virtual viewpoint image and the actual camera image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-112702, filed Jun. 18, 2019, which is hereby incorporated by reference wherein in its entirety.

What is claimed is:

1. An image processing apparatus comprising:
a first identifying unit configured to identify image-capturing conditions concerning a position and an orientation of an image-capturing apparatus which obtains a captured image of an image-capturing target region;
a second identifying unit configured to identify viewpoint conditions concerning a position and an orientation of a virtual viewpoint for a virtual viewpoint image generated based on a plurality of images of the image-capturing target region obtained by a plurality of image-capturing apparatuses at different positions; and
a display control unit configured to allow a display apparatus to display information indicating a degree of match between the identified image-capturing conditions and the identified viewpoint conditions before an image presented to a viewer is switched between the captured image and the virtual viewpoint image.

2. The image processing apparatus according to claim 1, wherein the information indicating the degree of match includes information indicating whether or not the identified image-capturing conditions and the identified viewpoint conditions substantially match each other.

3. The image processing apparatus according to claim 1, wherein the information indicating the degree of match includes information indicating a relationship between the position of the image-capturing apparatus and the position of the virtual viewpoint.

4. The image processing apparatus according to claim 1, wherein the information indicating the degree of match indicates at least one of a direction of the position of the image-capturing apparatus relative to the position of the virtual viewpoint and a distance between the virtual viewpoint and the image-capturing apparatus.

5. The image processing apparatus according to claim 1, wherein the information indicating the degree of match includes an image which represents the image-capturing target region viewed from a predetermined viewpoint, and on which information indicating the position of the image-capturing and information indicating the position of the virtual viewpoint are superimposed.

6. The image processing apparatus according to claim 1, wherein the information indicating the degree of match is displayed on the display apparatus together with the virtual viewpoint image.

7. The image processing apparatus according to claim 1, wherein the information indicating the degree of match is displayed on the display apparatus together with the captured image.

8. The image processing apparatus according to claim 1, wherein the information indicating the degree of match is displayed on the display apparatus together with the captured image and the virtual viewpoint image.

9. The image processing apparatus according to claim 1, wherein the information indicating the degree of match is displayed on the display apparatus together with information indicating whether control of bringing the image-capturing conditions and the viewpoint conditions close to each other is being executed.

10. The image processing apparatus according to claim 1, wherein the information indicating the degree of match is displayed on the display apparatus together with information indicating a remaining time until the image presented to the viewer is switched between the captured image and the virtual viewpoint image.

11. The image processing apparatus according to claim 1, wherein
the identified image-capturing conditions include the position, the orientation, and an angle of view of the image-capturing apparatus, and
the identified viewpoint conditions include the position, the orientation, and an angle of view of the virtual viewpoint.

12. The image processing apparatus according to claim 1, wherein the image presented to the viewer is outputted to at least one of a broadcasting facility and a webcasting server.

13. The image processing apparatus according to claim 1, further comprising:
an obtaining unit configured to obtain the captured image and the virtual viewpoint image; and
an output unit configured to perform image output while switching the captured image and the virtual viewpoint image thus obtained.

14. The image processing apparatus according to claim 1, further comprising a control unit configured to perform control of bringing the image-capturing conditions and the viewpoint conditions close to each other before the image presented to the viewer is switched between the captured image and the virtual viewpoint image.

15. The image processing apparatus according to claim 14, wherein the control changes the viewpoint conditions depending on the image-capturing conditions.

16. The image processing apparatus according to claim 1, further comprising a control unit configured to control, based on the image-capturing conditions, the viewpoint conditions after the image presented to the viewer is switched between the captured image and the virtual viewpoint image.

17. An image processing method comprising:
identifying image-capturing conditions concerning a position and an orientation of an image-capturing apparatus which obtains a captured image of an image-capturing target region;
identifying viewpoint conditions concerning a position and an orientation of a virtual viewpoint for a virtual viewpoint image generated based on a plurality of images of the image-capturing target region obtained by a plurality of image-capturing apparatuses at different positions; and
allowing a display apparatus to display information indicating a degree of match between the identified image-capturing conditions and the identified viewpoint conditions before an image presented to a viewer is switched between the captured image and the virtual viewpoint image.

18. The image processing method according to claim 17, wherein the information indicating the degree of match is displayed on the display apparatus together with the captured image and the virtual viewpoint image.

19. The image processing method according to claim 17, wherein the information indicating the degree of match is displayed on the display apparatus together with information indicating whether control of bringing the image-capturing conditions and the viewpoint conditions close to each other is being executed.

20. A non-transitory computer readable storage medium storing a program for causing a computer to perform a method of processing an image, the method comprising:
identifying image-capturing conditions concerning a position and an orientation of an image-capturing apparatus which obtains a captured image of an image-capturing target region;
identifying viewpoint conditions concerning a position and an orientation of a virtual viewpoint for a virtual viewpoint image generated based on a plurality of images of the image-capturing target region obtained by a plurality of image-capturing apparatuses at different positions; and
allowing a display apparatus to display information indicating a degree of match between the identified image-capturing conditions and the identified viewpoint conditions before an image presented to a viewer is switched between the captured image and the virtual viewpoint image.
